(19) United States
(12) Patent Application Publication
(10) Pub. No.: US 2025/0385909 A1
(43) Pub. Date: Dec. 18, 2025

(54) ACCESS CONTROL METHOD, SYSTEM, DEVICE, MEDIUM, AND PROGRAM PRODUCT

(71) Applicant: Beijing Volcano Engine Technology Co., Ltd., Beijing (CN)

(72) Inventor: Haichao LIU, Beijing (CN)

(21) Appl. No.: 19/070,146

(22) Filed: Mar. 4, 2025

(30) Foreign Application Priority Data
Jun. 17, 2024 (CN) 202410775419.8

(51) Int. Cl. H04L 9/40

(52) U.S. Cl. CPC H04L 63/0876; H04L 63/101; H04L 63/102

(57) ABSTRACT

The present disclosure relates to the field of computer technology, and discloses an access control method, a system, a device, a medium, and a program product. The method includes: displaying a login authentication page of a target application in response to an operation of making a terminal device access a first network; obtaining access configuration information of the first network, wherein the access configuration information comprises a communication interface, and the communication interface is configured to detect whether an application client of the target application is installed in the terminal device; and invoking the communication interface, and displaying first prompt information in response to a failure in invoking the communication interface, wherein the first prompt information is used to prompt to install the application client.

### CROSS-REFERENCE TO RELATED APPLICATION(S)

This application claims priority to Chinese Application No. 202410775419.8 filed on Jun. 17, 2024, the disclosure of which is incorporated herein by reference in its entirety.

### FIELD

The present disclosure relates to the field of computer technologies, and in particular, to an access control method, a system, a device, a medium, and a program product.

### BACKGROUND

At present, in a private network/dedicated network of an enterprise or another organization, security management software usually needs to be installed in a terminal device. Through the security management software, network access control, security detection, data leakage protection, and the like can be performed on the terminal device. In this way, network security is ensured.

### SUMMARY

In view of this, the embodiments of the present disclosure provide an access control method, an access control system, an electronic device, a computer-readable storage medium, and a computer program product, which can improve network security.

In one aspect, the present disclosure provides an access control method, including:
displaying a login authentication page of a target application in response to an operation of making a terminal device access a first network;
obtaining access configuration information of the first network, wherein the access configuration information comprises a communication interface, and the communication interface is configured to detect whether an application client of the target application is installed in the terminal device; and
invoking the communication interface, and displaying first prompt information in response to a failure in invoking the communication interface, wherein the first prompt information is used to prompt to install the application client.

In one aspect, the present disclosure provides an access control system, including:
a request receiving module, configured to display a login authentication page of a target application in response to an operation of making a terminal device access a first network;
a configuration information obtaining module, configured to obtain access configuration information of the first network, wherein the access configuration information comprises a communication interface, and the communication interface is configured to detect whether an application client of the target application is installed in the terminal device; and
an authentication module, configured to invoke the communication interface, and display first prompt information in response to a failure in invoking the communication interface, wherein the first prompt information is used to prompt to install the application client.

In another aspect, the present disclosure further provides a computer-readable storage medium, wherein the computer-readable storage medium is configured to store a computer program, and when the computer program is executed by a processor, the method described above is implemented.

In another aspect, the present disclosure further provides an electronic device, wherein the electronic device includes a processor and a memory, the memory is configured to store a computer program, and when the computer program is executed by the processor, the method described above is implemented.

In another aspect, the present disclosure further provides a computer program product, including a computer program, wherein when the computer program is executed by a processor, the method described above is implemented.

In the technical solutions of some embodiments of the present application, the access configuration information is set for the first network, so that after the login authentication page of the target application is displayed, the communication interface used to detect whether the application client is installed in the terminal device can be obtained from the access configuration information of the first network. By invoking the communication interface and in response to a failure in invoking the communication interface, it can be determined that the application client is not installed in the terminal device

### BRIEF DESCRIPTION OF THE DRAWINGS

The features and advantages of the present disclosure will be more clearly understood with reference to the drawings, which are illustrative and should not be construed as limiting the present disclosure, and in which:

FIG. 1 illustrates a schematic diagram of a network architecture according to an embodiment of the present application;

FIG. 2 illustrates a schematic flowchart of an access control method according to an embodiment of the present application;

FIG. 3 illustrates a schematic diagram of a network architecture according to another embodiment of the present application;

FIG. 4 illustrates a schematic diagram of modules of an access control system according to an embodiment of the present application; and

FIG. 5 illustrates a schematic diagram of an electronic device according to an embodiment of the present application.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely with reference to the drawings in the embodiments of the present disclosure. Obviously, the described embodiments are merely a part of the embodiments of the present disclosure, but not all of them. All other embodiments obtained by a person of ordinary skill in the art based on the embodiments of the present disclosure without creative efforts shall fall within the protection scope of the present disclosure.

The embodiments of the present disclosure will be described in more detail below with reference to the drawings. Although some embodiments of the present disclosure are shown in the drawings, it should be understood that the present disclosure can be implemented in various manners, and should not be construed as being limited to the embodiments set forth herein. On the contrary, these embodiments are provided for a thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and its variants should be understood as open inclusion, that is, “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

In this document, unless explicitly stated, performing a step “in response to A” does not mean that the step is performed immediately after “A”, but may include one or more intermediate steps.

It should be understood that the data involved in the technical solutions (including but not limited to the data itself, and the acquisition, use, storage, or deletion of the data) should comply with the requirements of corresponding laws, regulations, and related provisions.

It should be understood that, before using the technical solutions disclosed in the embodiments of the present disclosure, the type, scope of use, and use scenario of the information involved in the present disclosure should be informed to the related users and the authorization of the related users should be obtained in an appropriate manner according to the related laws and regulations, wherein the related users may include any type of right holder, for example, an individual, an enterprise, or a group.

For example, when receiving an active request from a user, prompt information is sent to the related user, so as to explicitly prompt the related user that the operation requested to be performed will require acquisition and use of the information of the related user, so that the related user can autonomously select whether to provide information to software or hardware such as an electronic device, an application, a server, or a storage medium that performs the operation of the technical solutions of the present disclosure according to the prompt information.

As an optional but non-restrictive implementation, the manner of sending the prompt information to the related user in response to receiving the active request from the related user may be, for example, a pop-up window, and the prompt information may be presented in the pop-up window in a text form. In addition, the pop-up window may also carry a selection control for the user to select “agree” or “disagree” to provide information to the electronic device.

It should be understood that the above process of notification and obtaining user authorization is merely illustrative and does not constitute a limitation on the implementations of the present disclosure, and other manners that meet the related laws and regulations may also be applied to the implementations of the present disclosure.

Office security usually involves security management of the network, identity, and terminal. By implementing proprietary network networking, access control, management of a terminal in the proprietary network, and information security protection, digital office can be made safer, more efficient, and easier to use. Security management at the network layer can ensure that a proprietary network such as an office network can operate safely and efficiently, thereby ensuring that service data can be transmitted and stored safely. Security management at the identity layer can improve the efficiency and security of identity authentication for users to access the proprietary network. Security management at the terminal layer can realize unified management of terminal devices in the proprietary network, data leakage prevention, and terminal threat protection, thereby ensuring the security of enterprise data.

In practical applications, security management of the network, identity, and terminal can realize technical association in multiple technical branches such as networking strategy, network admission and control, remote access, unified terminal management, terminal detection and response, enterprise data leakage prevention, and identity authentication management, thereby making digital office simpler, more efficient, and easier to implement.

At present, in a private network/dedicated network of an enterprise or another organization, security management software usually needs to be installed in a terminal device. Through the security management software, network access control, security detection, data leakage protection, and the like can be performed on the terminal device. In this way, network security is ensured. However, at present, when the terminal device accesses a network, there is no method for detecting whether the terminal device is installed with the security management software, so that network security cannot be effectively ensured.

Therefore, a method for improving network security is urgently needed.

In the technical solutions of some embodiments of the present application, the access configuration information is set for the first network, so that after the login authentication page of the target application is displayed, the communication interface used to detect whether the application client is installed in the terminal device can be obtained from the access configuration information of the first network. By invoking the communication interface and in response to a failure in invoking the communication interface, it can be determined that the application client is not installed in the terminal device. In this way, when the terminal device accesses the first network, for the terminal device that is not installed with the application client, prompt information for installing the application client can be given, so as to ensure that the terminal device that accesses the first network is installed with the application client. Furthermore, through the application client, network security management can be performed on the terminal device, thereby improving the security of the private network/dedicated network such as an enterprise office network.

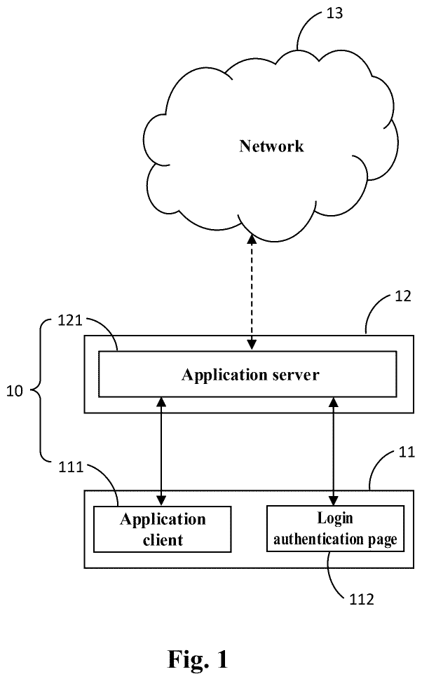

FIG. 1 illustrates a schematic diagram of a network architecture according to an embodiment of the present application. The network architecture shown in FIG. 1 includes a terminal device 11, a management platform 12, and a network 13. The network 13 may be a private network/dedicated network, such as an enterprise network, a school network, or the like. The management platform 12 may include one or more servers. The terminal device 11 and the management platform 12 may be installed with a target application 10. Based on the target application 10, network access control, security detection, data leakage protection, and the like can be performed on the terminal device 11 when the terminal device 11 accesses the network 13.

Specifically, the target application 10 may include an application client 111 and an application server 121. The application client 111 is installed in the terminal device 11, and the application server 121 is installed in the management platform 12. Various policies may be configured in the application server 121 in advance. These policies include but are not limited to an access control policy for the network 13, a security detection policy for the terminal device 11, a data leakage protection policy, and the like. Based on these policies, the application client 111 and the application server 121 cooperate to manage the terminal device 11.

For example, the access control policy may include a first user name and a first password for performing identity authentication on respective authorized users of the network 13, and network resources that the respective authorized users are allowed to access. When a user needs to use a network resource in the network 13, the application client 111 may be run in the terminal device 11, and a second user name and a second password may be input in an interface of the application client 111. The application client 111 may send the second user name and the second password to the application server 121 for authentication. If a second user name and a second password of one of the authorized users A in the application server 121 match the first user name and the first password, it may represent that the authentication is passed. After the authentication is passed, the terminal device 11 may access the network 13, and the application server 121 may control network resources that the terminal device 11 is allowed to access based on the access control policy corresponding to the authorized user A.

For another example, the application server 121 may send the security detection policy to the application client 111, and the application client 111 performs security detection on the terminal device 11 according to the security detection policy, so as to ensure network security.

In the network architecture shown in FIG. 1, in the case where the terminal device 11 is not installed with the application client 111, if the terminal device 11 needs to access the network 13, a browser may be used as a web client, and a login authentication page 112 of the target application 10 is displayed through the browser. The user may input a second user name and a second password on the login authentication page 112. The browser sends the second user name and the second password to the application server 121 for authentication. In this manner of accessing the network 13 through the login authentication page 112, although network access control can be performed on the terminal device 11, security detection, data leakage protection, and the like may not be performed on the terminal device 11. Therefore, for the sake of network security, when the terminal device 11 accesses the network 13, the terminal device 11 is usually required to be installed with the application client 111. However, at present, for the terminal device 11 accessing the network 13, there is no method for determining whether the terminal device 11 is installed with the application client 111, resulting in that network security of the network 13 cannot be effectively ensured.

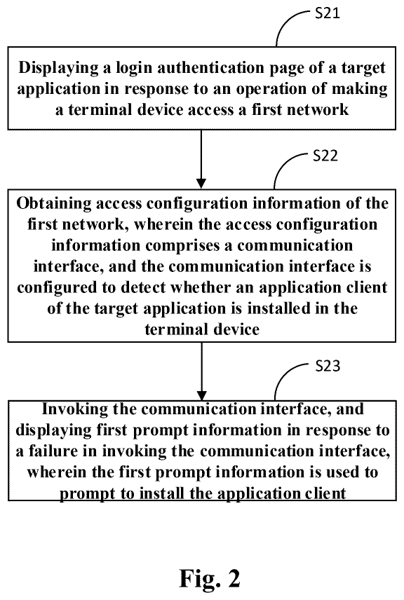

In view of this, the present application provides an access control method, which can detect whether the application client 111 is installed in the terminal device 11 when the terminal device 11 accesses the network 13, so as to improve network security. The access control method may be applied to the terminal device 11. Please refer to FIG. 2, which illustrates a schematic flowchart of an access control method according to an embodiment of the present application. In FIG. 2, the access control method includes the following steps.

Step S21: displaying a login authentication page 112 of a target application 10 in response to an operation of making a terminal device 11 access a first network.

The first network is the network 13 in FIG. 1. For the first network and the login authentication page 112, reference may be made to the related description in FIG. 1, which will not be repeated here.

The operation of making the terminal device 11 access the first network refers to an operation of making the terminal device 11 access the first network initiated by the user in the case where the terminal device 11 is not accessed to the first network. For example, in the case where the terminal device 11 is not accessed to the first network, the user requests to access a network resource in the first network through the terminal device 11, which may trigger to display the login authentication page 112 of the target application 10. For another example, the first network may have a network entrance. The terminal device 11 may display the network entrance in the form of an icon. The user clicks or double-clicks on the network entrance, which may trigger to display the login authentication page 112 of the target application 10. For another example, the user communicatively connects the terminal device 11 to the first network by means of a wired connection, which may trigger to display the login authentication page 112 of the target application 10.

Further, the login authentication page 112 may be obtained by the terminal device 11 from the application server 121, and may specifically include page code and a visible page for display locally by the terminal device 11. The page code may be background code of the login authentication page 112, that is, content that is not displayed by the terminal device 11. After the visible page of the login authentication page 112 is displayed, the terminal device 11 may execute the page code. When the page code is executed, the following steps S32 and S33 may be implemented.

Step S22: obtaining access configuration information of the first network, wherein the access configuration information comprises a communication interface, and the communication interface is configured to detect whether an application client 111 of the target application 10 is installed in the terminal device 11.

The access configuration information may be information preset and stored in the application server 121, and is configured to perform network security management on the first network. The page code may include a storage address of the access configuration information. In the process of running the page code, the access configuration information may be obtained at the corresponding storage address.

In this embodiment, performing network security management on the first network may include: the terminal device 11 that accesses the first network needs to be installed with the application client 111. Correspondingly to the network security management, the access configuration information may include the communication interface. The communication interface may be a liveness detection interface of the application client 111, and is configured to detect whether the terminal device 11 that accesses the first network is installed with the application client 111. Specifically, in the case where the terminal device 11 is installed with the application client 111, the communication interface may be successfully invoked; and in the case where the terminal device 11 is not installed with the application client 111, the communication interface fails to be invoked. Therefore, whether the terminal device 11 that accesses the first network is installed with the application client 111 may be detected based on an invocation result of the communication interface.

Step S23: invoking the communication interface, and displaying first prompt information in response to a failure in invoking the communication interface, wherein the first prompt information is used to prompt to install the application client 111.

As described in step S22, if the communication interface fails to be invoked, it may be determined that the application client 111 is not installed in the terminal device 11. In this case, the first prompt information may be displayed to prompt the user to install the application client 111 in the terminal device 11. The first prompt information may include a download link of the application client 111. In this way, installation guidance of the application client 111 is performed.

In this embodiment, it is considered that after the login authentication page 112 is displayed, the user may input information (such as a user name and a password) for identity authentication on the login authentication page 112. In response to the failure in invoking the communication interface, there is no need to send the information input by the user to the application server 121 for authentication, so as to avoid accessing the terminal device 11 to the first network in the case where the terminal device 11 is not installed with the application client 111.

In other embodiments, the login authentication page 112 initially displayed in step S21 may not include an information input area. The information input area is displayed on the login authentication page 112 in response to a success in invoking the communication interface, so that it is convenient for the user to input information for identity authentication in the information input area. In this way, it is possible to avoid that the terminal device 11 is mistakenly accessed to the first network after the user enters the information for identity authentication on the login authentication page 112 in the case where the terminal device 11 is not installed with the application client 111.

Further, corresponding to the failure in invoking the communication interface, in response to the success in invoking the communication interface, it may be determined that the application client 111 is installed in the terminal device 11. In the case where the application client 111 is installed in the terminal device 11, the information for identity authentication input by the user on the login authentication page 112 through the terminal device 11 may be obtained, and the obtained information is sent to the application server 121 of the target application 10 to perform identity authentication on the user. In this way, the terminal device 11 may be accessed to the first network in time in the case where the application client 111 is installed in the terminal device 11.

In conclusion, in the technical solutions of some embodiments of the present application, the access configuration information is set for the first network, so that after the login authentication page 112 of the target application 10 is displayed, the communication interface used to detect whether the application client 111 is installed in the terminal device 11 can be obtained from the access configuration information of the first network. By invoking the communication interface and in response to a failure in invoking the communication interface, it can be determined that the application client 111 is not installed in the terminal device 11. In this way, when the terminal device 11 accesses the first network, for the terminal device 11 that is not installed with the application client 111, prompt information for installing the application client 111 can be given, so as to ensure that the terminal device 11 that accesses the first network is installed with the application client 111. Furthermore, through the application client 111, network security management can be performed on the terminal device 11, thereby improving the security of the private network/dedicated network such as an enterprise office network.

The solution of the present application is further described below.

In some embodiments, when performing network security management on the first network, in addition to requiring that the terminal device 11 that accesses the first network needs to be installed with the application client 111, there may be other management requirements, such as that a device model of the terminal device 11 needs to be a specified model, and a version of the application client 111 in the terminal device 11 must be a target version that meets the requirements. This means that after it is determined that the application client 111 is installed in the terminal device 11, it may be necessary to detect some other specified information in the terminal device 11, and the terminal device 11 is allowed to access the first network only when the specified information also meets the requirements. The specified information may be collected through the communication interface. After the communication interface is successfully invoked, the response information of the communication interface may include the specified information.

Based on the above description, sending the obtained information to the application server 121 of the target application 10 to perform the identity authentication on the user may include:
receiving response information returned by the communication interface, wherein the response information includes one or more of: device information of the terminal device 11 and running information of the application client 111;
determining, based on the response information, whether the terminal device 11 is allowed to access the first network;
sending the obtained information to the application server 121 to perform identity authentication on the user in response to the terminal device 11 being allowed to access the first network; and
displaying second prompt information in response to the terminal device 11 not being allowed to access the first network, wherein the second prompt information is used to prompt a reason why the terminal device 11 is not allowed to access the first network.

In the foregoing embodiment, after it is determined that the application client 111 is installed in the terminal device 11, whether the terminal device 11 can access the first network is further determined based on the response information of the communication interface. In this way, network security can be further improved on the basis of the embodiment of FIG. 2.

The following uses some specific embodiments to specifically describe how to determine, based on the response information, whether the terminal device 11 is allowed to access the first network.

In some embodiments, it is considered that although the application client 111 is installed and run in the terminal device 11, the application client 111 may be in a not login state. The not login state means that a connection is not established between the application client 111 and the application server 121 based on information representing the identity of the user. In this case, the application client 111 still cannot perform network security management on the first network. In view of this, the running information in the response information may include a login identification representing whether the application client 111 is in the login state. When a value of the login identification is a first value (for example, 1), it may represent that the application client 111 is in the login state, and when the value of the login identification is a second value (for example, 0), it may represent that the application client 111 is not in the login state. Based on the above description, the determining whether the terminal device 11 is allowed to access the first network may include:
determining that the terminal device 11 is allowed to access the first network in response to the login identification representing that the application client 111 is in the login state (that is, the value of the login identification is the first value); and
determining that the terminal device 11 is not allowed to access the first network in response to the login identification representing that the application client 111 is in the not login state (that is, the value of the login identification is the second value).

In this way, the case where the application client 111 of the terminal device 11 is not logged in can be prevented, the reliability of the solution is improved, and network security is further improved.

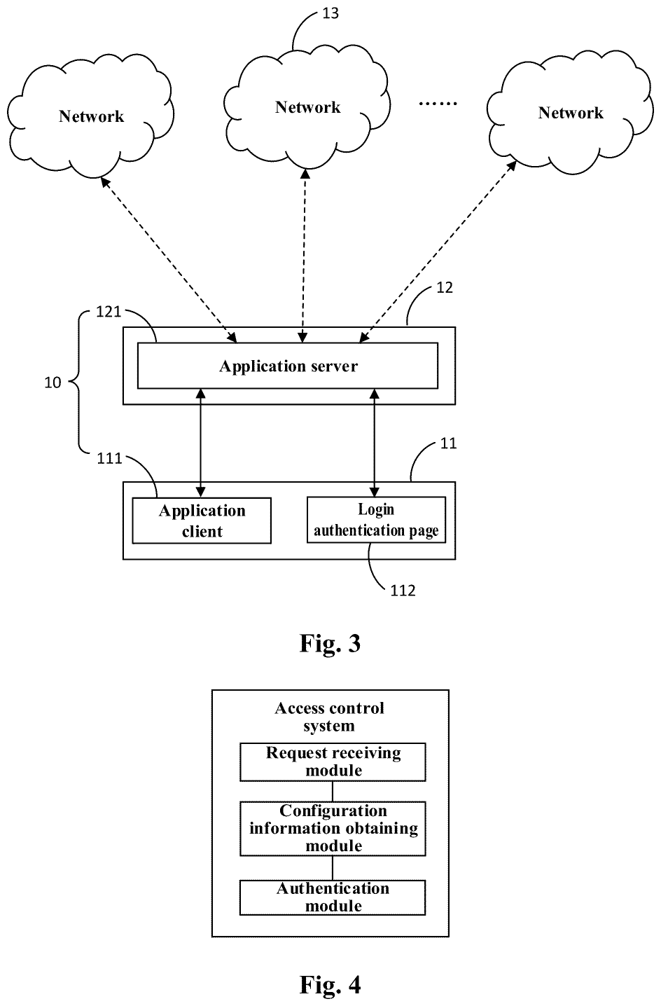

With reference to FIG. 3, in a network architecture of some embodiments, there may be multiple networks. Each network may have a unique network identification, and each network may have its own corresponding access configuration information. The first network may be one of the multiple networks. In response to the operation of making the terminal device 11 access the first network, the terminal device 11 may send a first network identification of the first network to the application server 121. Based on the first network identification, the application server 121 may specify a storage address corresponding to the access configuration information of the first network in page code of the returned login authentication page 112. In this way, in the process of running the page code, the terminal device 11 may obtain the access configuration information corresponding to the first network, and then may perform network security management on the first network based on the access configuration information.

However, the network architecture shown in FIG. 3 has a problem that before the terminal device 11 accesses the first network through the login authentication page 112, the user may input the following information in the interface of the application client 111: information for identity authentication and a network identification of a second network different from the first network. In this way, after the authentication is passed, the application server 121 may access the terminal device 11 to the second network based on the network identification. At the same time, the application client 111 may perform network security management on the terminal device 11 according to a network security management policy of the second network. Then, after the terminal device 11 accesses the first network through the login authentication page 112, network security management can no longer be performed on the first network. Therefore, in order to avoid the above problem, it may be required that the second network and the first network must be the same network.

Based on the above description, the obtained access configuration information of the first network may include the first network identification of the first network, and in the case where the application client 111 in the running state is connected to the second network, the response information may include a second network identification of the second network. The determining whether the terminal device 11 is allowed to access the first network may include:
determining whether the first network identification and the second network identification are the same;
determining that the terminal device 11 is allowed to access the first network in response to the first network identification and the second network identification being the same; and
determining that the terminal device 11 is not allowed to access the first network in response to the first network identification and the second network identification not being the same.

In this way, the problem that the first network and the second network are different can be effectively avoided, and network security of the first network is ensured.

In some embodiments, the first network may have a requirement on an operating system of the terminal device 11. Therefore, the device information may include a current version number of the operating system installed in the terminal device 11, and the access configuration information may include a version number scope of the operating system required to be installed in the terminal device 11 that is allowed to access the first network. The determining whether the terminal device 11 is allowed to access the first network may include:
determining whether the current version number is within the version number scope;
determining that the terminal device 11 is allowed to access the first network in response to the current version number being within the version number scope; and
determining that the terminal device 11 is not allowed to access the first network in response to the current version number not being within the version number scope.

In this way, the version of the operating system of the terminal device 11 can be controlled when accessing the first network, thereby improving network security.

In some embodiments, in order to prevent data in the first network from leaking from the terminal device 11, the device information may further include a screen lock identification. The screen lock identification is used to represent whether the operating system of the terminal device 11 has a screen lock password. The determining whether the terminal device 11 is allowed to access the first network may include:
determining that the terminal device 11 is allowed to access the first network in response to the screen lock identification representing that the operating system of the terminal device 11 has the screen lock password; and
determining that the terminal device 11 is not allowed to access the first network in response to the screen lock identification representing that the operating system of the terminal device 11 does not have the screen lock password.

In this way, data in the first network can be prevented from leaking from the terminal device 11, thereby improving network security.

Further, in some embodiments, one or more browsers are installed in the terminal device 11. The login authentication page 112 is run in a first browser in the terminal device 11. There may be data interaction between the application client 111 and the first browser. For example, after the application client 111 is installed in the terminal device 11, the information for identity authentication input by the user on the login authentication page 112 may be directly synchronized to the application client 111. In this way, the user does not need to input the information for identity authentication in the application client 111 again.

Generally, the data interaction between the application client 111 and the browser is cross-domain interaction, which requires the browser to support the cross-domain function. Therefore, before invoking the communication interface, the method of the present application may further include:
determining whether the first browser supports the cross-domain function; and
displaying third prompt information and stopping invoking the communication interface in response to the first browser not supporting the cross-domain function, wherein the third prompt information is used to prompt to replace the first browser.

In this way, the problem of data interaction failure between the application client 111 and the first browser due to the first browser not supporting the cross-domain function is avoided.

Further, in some embodiments, in the case where the user identity authentication is passed, for network security, the cross-domain function of the first browser is often required to be disabled. In view of this, in response to the communication interface being successfully invoked, before sending the information obtained from the login authentication page 112 to the application server 121, the method of the present application may further include:
sending the obtained information to the application server 121 in response to the cross-domain function of the first browser being set to a disabled state; and
displaying fourth prompt information and stopping sending the obtained information to the application server 121 in response to the cross-domain function of the first browser being in an enabled state, wherein the fourth prompt information is used to prompt to disable the cross-domain function of the first browser.

In this way, it is ensured that the cross-domain function of the first browser is in the disabled state after the user identity is passed, thereby improving network security.

Further, in some embodiments, whether the first browser supports the cross-domain function may be determined based on the following method:
a user agent identification of the first browser is obtained, wherein the user agent identification includes a cross-domain identification representing whether the first browser supports the cross-domain function;
it is determined that the first browser supports the cross-domain function in response to the cross-domain identification being a first value; and
it is determined that the first browser does not support the cross-domain function in response to the cross-domain identification being a second value.

Specifically, the user agent identification may also be referred to as a UA (User Agent) of the first browser. The UA may be an inherent attribute of the first browser, and it is relatively simple to determine whether the first browser supports cross-domain based on the cross-domain identification in the UA.

In other embodiments, the problem that the first browser does not support the cross-domain function or other security limitations may also be solved by configuring the domain name and certificate for the local service of the application client 111.

In some embodiments, the application client 111 includes a local service, the local service includes a liveness detection interface, and the communication interface obtained from the access configuration information is the liveness detection interface of the local service. It may be understood that only in the case where the terminal device 11 supports running the local service, the application client 111 can be successfully installed in the terminal device 11, and the liveness detection interface can be successfully invoked. Therefore, the invoking the communication interface may include:
determining whether the terminal device 11 supports the local service; and
invoking the liveness detection interface in response to the terminal device 11 supporting the local service.

Specifically, the local service may also be referred to as a LocalServer. Generally, in the case where the operating system of the terminal device 11 is a desktop operating system (such as Windows, macOS, Linux), the terminal device 11 may support the local service; and in the case where the operating system of the terminal device 11 is not the desktop operating system, the terminal device 11 may not support the local service. Therefore, whether the terminal device 11 supports the local service may be determined according to the operating system of the terminal device 11.

Since the liveness detection interface may be an inherent interface of the local service, using the interface as the communication interface for detecting whether the application client 111 is installed in the terminal device 11 can reduce interface development.

In some embodiments, in response to the terminal device 11 not supporting the local service, the method of the present application may further include:
not starting invocation of the liveness detection interface, and displaying fifth prompt information, wherein the fifth prompt information is used to prompt to replace the terminal device 11.

It can be known from the above description that, in the case where the terminal device 11 does not support the local service, the communication interface fails to be invoked, and the application client 111 also fails to be installed in the terminal device 11. Therefore, by prompting to replace the terminal device 11, the problem that the application client 111 fails to be installed, resulting in that the terminal device cannot access the first network, can be prevented.

So far, all descriptions of the solutions of the present application are completed.

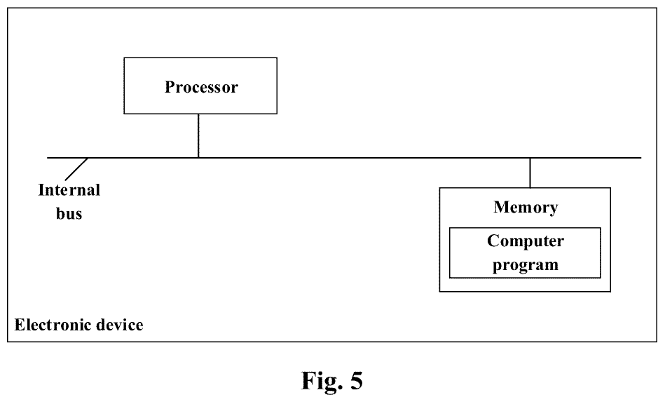

FIG. 4 illustrates a schematic diagram of modules of an access control system according to an embodiment of the present application. In FIG. 4, the access control system includes:
a request receiving module, configured to display a login authentication page of a target application
in response to an operation of making a terminal device access a first network;
a configuration information obtaining module, configured to obtain access configuration information of the first network, wherein the access configuration information comprises a communication interface, and the communication interface is configured to detect whether an application client of the target application is installed in the terminal device; and
an authentication module, configured to invoke the communication interface, and display first prompt information in response to a failure in invoking the communication interface, wherein the first prompt information is used to prompt to install the application client.

In some embodiments, in response to a success in invoking the communication interface, the configuration information obtaining module is further configured to:
determine that the terminal device is installed with the application client; and
obtain information for identity authentication input by a user on the login authentication page through the terminal device, and send the obtained information to an application server of the target application to perform identity authentication on the user.

In some embodiments, the configuration information obtaining module is further configured to:
receive response information returned by the communication interface, wherein the response information includes one or more of: device information of the terminal device and running information of the application client;
determine, based on the response information, whether the terminal device is allowed to access the first network;
send the obtained information to the application server to perform the identity authentication on the user in response to the terminal device being allowed to access the first network; and
display second prompt information in response to the terminal device not being allowed to access the first network, wherein the second prompt information is used to prompt a reason why the terminal device is not allowed to access the first network.

In some embodiments, the running information includes a login identification representing whether the application client is in the login state; and the configuration information obtaining module is further configured to:
determine that the terminal device is allowed to access the first network in response to the login identification representing that the application client is in the login state; and
determine that the terminal device is not allowed to access the first network in response to the login identification representing that the application client is in the not login state.

In some embodiments, the access configuration information includes a first network identification of the first network, and in the case where the application client in the running state is connected to the second network, the response information includes a second network identification of the second network; and the configuration information obtaining module is further configured to:
determine whether the first network identification and the second network identification are the same;
determine that the terminal device is allowed to access the first network in response to the first network identification and the second network identification being the same; and
determine that the terminal device is not allowed to access the first network in response to the first network identification and the second network identification not being the same.

In some embodiments, the device information includes a current version number of the operating system installed in the terminal device, and the access configuration information includes a version number scope of the operating system required to be installed in the terminal device that is allowed to access the first network. The configuration information obtaining module is further configured to:
determine whether the current version number is within the version number scope;
determine that the terminal device is allowed to access the first network in response to the current version number being within the version number scope; and
determine that the terminal device is not allowed to access the first network in response to the current version number not being within the version number scope.

In some embodiments, the device information includes a screen lock identification, and the screen lock identification is used to represent whether an operating system of the terminal device has a screen lock password. The configuration information obtaining module is further configured to:
determine that the terminal device is allowed to access the first network in response to the screen lock identification representing that the operating system of the terminal device has the screen lock password; and
determine that the terminal device is not allowed to access the first network in response to the screen lock identification representing that the operating system of the terminal device does not have the screen lock password.

In some embodiments, the login authentication page is run in a first browser in the terminal device. Before invoking the communication interface, the configuration information obtaining module is further configured to:
determine whether the first browser supports a cross-domain function; and
display third prompt information and stop invoking the communication interface in response to the first browser not supporting the cross-domain function, wherein the third prompt information is used to prompt to replace the first browser.

In some embodiments, before sending the information obtained from the login authentication page to the application server, the configuration information obtaining module is further configured to:
send the obtained information to the application server in response to a cross-domain function of the first browser being set to a disabled state; and
display fourth prompt information and stop sending the obtained information to the application server in response to the cross-domain function of the first browser being in an enabled state, wherein the fourth prompt information is used to prompt to disable the cross-domain function of the first browser.

In some embodiments, the configuration information obtaining module specifically determines whether the first browser supports the cross-domain function based on the following method:
a user agent identification of the first browser is obtained, wherein the user agent identification includes a cross-domain identification representing whether the first browser supports the cross-domain function;
it is determined that the first browser supports the cross-domain function in response to the cross-domain identification being a first value; and
it is determined that the first browser does not support the cross-domain function in response to the cross-domain identification being a second value.

In some embodiments, the application client includes a local service, the local service includes a liveness detection interface, and the communication interface obtained from the access configuration information is the liveness detection interface of the local service; and the authentication module is further configured to:
determine whether the terminal device supports the local service; and
invoke the liveness detection interface in response to the terminal device supporting the local service.

In some embodiments, in response to the terminal device not supporting the local service, the authentication module is further configured to:
not start to invoke the liveness detection interface, and display fifth prompt information, wherein the fifth prompt information is used to prompt to replace the terminal device.

In some embodiments, the login authentication page has corresponding page code, and when the page code is executed, the configuration information obtaining module is further configured to obtain the access configuration information of the first network, wherein the access configuration information comprises the communication interface, and the communication interface is configured to detect whether the application client of the target application is installed in the terminal device; and the authentication module is further configured to invoke the communication interface, and display the first prompt information in response to a failure in invoking the communication interface, wherein the first prompt information is used to prompt to install the application client.

FIG. 5 illustrates a schematic diagram of an electronic device according to an embodiment of the present application. The electronic device includes a processor and a memory, the memory is configured to store a computer program, and when the computer program is executed by the processor, the method described above is implemented.

The processor may be a central processing unit (Central Processing Unit, CPU). The processor may also be another general-purpose processor, a digital signal processor (Digital Signal Processor, DSP), an application-specific integrated circuit (Application Specific Integrated Circuit, ASIC), a field programmable gate array (Field-Programmable Gate Array, FPGA), or other programmable logic device, discrete gate or transistor logic device, discrete hardware component, or the like, or a combination of the foregoing chips.

The memory, as a non-transitory computer-readable storage medium, can be used to store non-transitory software programs, non-transitory computer-executable programs, and modules, such as program instructions/modules corresponding to the methods in the implementations of the present disclosure. The processor executes various functional applications and data processing of the processor by running the non-transitory software programs, instructions, and modules stored in the memory, that is, the methods in the above method implementations are implemented.

The memory may include a program storage area and a data storage area, wherein the program storage area may store an operating system and applications required for at least one function; and the data storage area may store data created by the processor, etc. In addition, the memory may include a high-speed random access memory, and may also include a non-transitory memory, for example, at least one magnetic disk storage device, a flash memory device, or other non-transitory solid-state storage devices. In some implementations, the memory may optionally include a memory that is remotely set relative to the processor, and these remote memories may be connected to the processor through a network. Examples of the above network include but are not limited to the Internet, an intranet, a local area network, a mobile communication network, and a combination thereof.

An implementation of the present application further provides a computer-readable storage medium, wherein the computer-readable storage medium is configured to store a computer program, and when the computer program is executed by a processor, the method described above is implemented.

The present disclosure further provides a computer program product, including a computer program, wherein when the computer program is executed by a processor, the method described above is implemented.

Although the embodiments of the present disclosure have been described with reference to the drawings, those skilled in the art may make various modifications and variations without departing from the spirit and scope of the present disclosure, and such modifications and variations all fall within the scope defined by the appended claims.

I/We claim:

1. An access control method, comprising:
displaying a login authentication page of a target application in response to an operation of making a terminal device access a first network;
obtaining access configuration information of the first network, wherein the access configuration information comprises a communication interface, and the communication interface is configured to detect whether an application client of the target application is installed in the terminal device; and
invoking the communication interface, and displaying first prompt information in response to a failure in invoking the communication interface, wherein the first prompt information is used to prompt to install the application client.

2. The method according to claim 1, wherein in response to a success in invoking the communication interface, the method further comprises:
determining that the terminal device is installed with the application client; and
obtaining information for identity authentication input by a user on the login authentication page through the terminal device, and sending the obtained information to an application server of the target application to perform identity authentication on the user.

3. The method according to claim 2, wherein sending the obtained information to the application server of the target application to perform the identity authentication on the user comprises:
receiving response information returned by the communication interface, wherein the response information comprises one or more of: device information of the terminal device and running information of the application client;
determining, based on the response information, whether the terminal device is allowed to access the first network;
sending the obtained information to the application server to perform the identity authentication on the user in response to the terminal device being allowed to access the first network; and
displaying second prompt information in response to the terminal device not being allowed to access the first network, wherein the second prompt information is used to prompt a reason why the terminal device is not allowed to access the first network.

4. The method according to claim 3, wherein the running information comprises a login identification representing whether the application client is in a login state; and
determining whether the terminal device is allowed to access the first network comprises:
determining that the terminal device is allowed to access the first network in response to the login identification representing that the application client is in the login state; and
determining that the terminal device is not allowed to access the first network in response to the login identification representing that the application client is in an not login state.

5. The method according to claim 3, wherein the access configuration information comprises a first network identification of the first network, and in a case wherein the application client in a running state is connected to a second network, the response information comprises a second network identification of the second network; and
determining whether the terminal device is allowed to access the first network comprises:
determining whether the first network identification and the second network identification are the same;
determining that the terminal device is allowed to access the first network in response to the first network identification and the second network identification being the same; and
determining that the terminal device is not allowed to access the first network in response to the first network identification and the second network identification not being the same.

6. The method according to claim 3, wherein the device information comprises a current version number of an operating system installed in the terminal device, and the access configuration information comprises a version number scope of the operating system required to be installed in the terminal device that is allowed to access the first network; and
determining whether the terminal device is allowed to access the first network comprises:
determining whether the current version number is within the version number scope;
determining that the terminal device is allowed to access the first network in response to the current version number being within the version number scope; and
determining that the terminal device is not allowed to access the first network in response to the current version number not being within the version number scope.

7. The method according to claim 3, wherein the device information comprises a screen lock identification, and the screen lock identification is used to represent whether an operating system of the terminal device has a screen lock password; and
determining whether the terminal device is allowed to access the first network comprises:
determining that the terminal device is allowed to access the first network in response to the screen lock identification representing that the operating system of the terminal device has the screen lock password; and
determining that the terminal device is not allowed to access the first network in response to the screen lock identification representing that the operating system of the terminal device does not have the screen lock password.

8. The method according to claim 3, wherein the login authentication page is run in a first browser in the terminal device; and before invoking the communication interface, the method further comprises:
determining whether the first browser supports a cross-domain function; and
displaying third prompt information and stopping invoking the communication interface in response to the first browser not supporting the cross-domain function, wherein the third prompt information is used to prompt to replace the first browser.

9. The method according to claim 8, wherein before sending the information obtained from the login authentication page to the application server, the method further comprises:
sending the obtained information to the application server in response to the cross-domain function of the first browser being set to a disabled state; and
displaying fourth prompt information and stopping sending the obtained information to the application server in response to the cross-domain function of the first browser being in an enabled state, wherein the fourth prompt information is used to prompt to disable the cross-domain function of the first browser.

10. The method according to claim 8, wherein whether the first browser supports the cross-domain function is determined based on the following method:
a user agent identification of the first browser is obtained, wherein the user agent identification comprises a cross-domain identification representing whether the first browser supports the cross-domain function;
it is determined that the first browser supports the cross-domain function in response to the cross-domain identification being a first value; and
it is determined that the first browser does not support the cross-domain function in response to the cross-domain identification being a second value.

11. The method according to claim 1, wherein the application client comprises a local service, the local service comprises a liveness detection interface, and the communication interface obtained from the access configuration information is the liveness detection interface of the local service; and
invoking the communication interface comprises:
determining whether the terminal device supports the local service; and
invoking the liveness detection interface in response to the terminal device supporting the local service.

12. The method according to claim 11, wherein in response to the terminal device not supporting the local service, the method further comprises:
not starting invocation of the liveness detection interface, and displaying fifth prompt information, wherein the fifth prompt information is used to prompt to replace the terminal device.

13. The method according to claim 1, wherein the login authentication page has corresponding page code, and when the page code is executed, the following method is implemented:
obtaining the access configuration information of the first network, wherein the access configuration information comprises the communication interface, and the communication interface is configured to detect whether the application client of the target application is installed in the terminal device; and
invoking the communication interface, and displaying the first prompt information in response to the failure in invoking the communication interface, wherein the first prompt information is used to prompt to install the application client.

14. A non-transitory computer-readable storage medium, wherein the computer-readable storage medium is configured to store a computer program, and the computer program, when being executed by a processor, implements an access control method comprising:
displaying a login authentication page of a target application in response to an operation of making a terminal device access a first network;
obtaining access configuration information of the first network, wherein the access configuration information comprises a communication interface, and the communication interface is configured to detect whether an application client of the target application is installed in the terminal device; and
invoking the communication interface, and displaying first prompt information in response to a failure in invoking the communication interface, wherein the first prompt information is used to prompt to install the application client.

15. The non-transitory computer-readable storage medium according to claim 14, wherein in response to a success in invoking the communication interface, the method further comprises:
determining that the terminal device is installed with the application client; and
obtaining information for identity authentication input by a user on the login authentication page through the terminal device, and sending the obtained information to an application server of the target application to perform identity authentication on the user.

16. The non-transitory computer-readable storage medium according to claim 15, wherein sending the obtained information to the application server of the target application to perform the identity authentication on the user comprises:
receiving response information returned by the communication interface, wherein the response information comprises one or more of: device information of the terminal device and running information of the application client;
determining, based on the response information, whether the terminal device is allowed to access the first network;
sending the obtained information to the application server to perform the identity authentication on the user in response to the terminal device being allowed to access the first network; and
displaying second prompt information in response to the terminal device not being allowed to access the first network, wherein the second prompt information is used to prompt a reason why the terminal device is not allowed to access the first network.

17. The non-transitory computer-readable storage medium according to claim 16, wherein the running information comprises a login identification representing whether the application client is in a login state; and
determining whether the terminal device is allowed to access the first network comprises:
determining that the terminal device is allowed to access the first network in response to the login identification representing that the application client is in the login state; and
determining that the terminal device is not allowed to access the first network in response to the login identification representing that the application client is in an not login state.

18. The non-transitory computer-readable storage medium according to claim 16, wherein the access configuration information comprises a first network identification of the first network, and in a case wherein the application client in a running state is connected to a second network, the response information comprises a second network identification of the second network; and
determining whether the terminal device is allowed to access the first network comprises:
determining whether the first network identification and the second network identification are the same;
determining that the terminal device is allowed to access the first network in response to the first network identification and the second network identification being the same; and
determining that the terminal device is not allowed to access the first network in response to the first network identification and the second network identification not being the same.

19. The non-transitory computer-readable storage medium according to claim 16, wherein the device information comprises a current version number of an operating system installed in the terminal device, and the access configuration information comprises a version number scope of the operating system required to be installed in the terminal device that is allowed to access the first network; and
determining whether the terminal device is allowed to access the first network comprises:
determining whether the current version number is within the version number scope;
determining that the terminal device is allowed to access the first network in response to the current version number being within the version number scope; and
determining that the terminal device is not allowed to access the first network in response to the current version number not being within the version number scope.

20. An electronic device, wherein the electronic device comprises a processor and a memory, the memory is configured to store a computer program, and the computer program, when being executed by the processor, implements an access control method comprising:
displaying a login authentication page of a target application in response to an operation of making a terminal device access a first network;
obtaining access configuration information of the first network, wherein the access configuration information comprises a communication interface, and the communication interface is configured to detect whether an application client of the target application is installed in the terminal device; and
invoking the communication interface, and displaying first prompt information in response to a failure in invoking the communication interface, wherein the first prompt information is used to prompt to install the application client.
